(19) United States
(12) Patent Application Publication
(10) Pub. No.: US 2007/0174913 A1
(43) Pub. Date: Jul. 26, 2007

(54) Method and system for acquiring particular data upon start of a particular program

(75) Inventor: Naoto Kuroda, Nagano-ken (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 10/549,443

(22) PCT Filed: Mar. 17, 2004
(86) PCT No.: PCT/JP04/03533

§ 371 Date: Dec. 14, 2006

(30) Foreign Application Priority Data
Mar. 17, 2003 (JP) 2003-072372

(51) Int. Cl. G06F 12/14

(52) U.S. Cl. 726/24

(57) ABSTRACT

A processing unit (100) executing a network connection control program (17) detects an activation instruction for a mailer (13) or a browser (14). Upon detection of the activation instruction, a dial-up program (15) is activated and a network connection is established, so that a definition file amendment acquisition program (18) is activated and amendment of a definition file is acquired from a server (20). After this, the mailer (13) or the browser (14) whose activation has been instructed is activated.

### TECHNICAL FIELD

The present invention relates to a technique of acquiring particular data through a network at the time of starting a particular program, and particularly to a technique usable for acquiring data that are used for enhancing computer network security.

### BACKGROUND ART

As a countermeasure against computer viruses, antivirus software is installed on a computer. And, usually at the time when the computer is activated, the antivirus software is activated also. When the computer is connected to a network, the antivirus software communicates with some server through the network at regular intervals, to acquire amendment of a virus definition file stored in the server. Namely, in the case where the version of the virus definition file has been revised, the antivirus software acquires a difference between the versions before and after the revision, or, for example, acquires the revised file as a whole, to update the virus definition file. Thereafter, similar processing is repeated automatically and periodically. For example, Patent Document 1 (Japanese Non-examined Patent Laid-open No. 2002-259150) discloses such a technique of updating a virus definition file.

However, the above-described conventional technique has the following problems to be solved.

Speaking of how to use a computer, sometimes a computer is used locally, i.e., as a stand-alone computer that is not connected to a network. Further, sometimes a computer is activated and used locally, before the computer is connected to a network. For example, in the case of a computer (such as a mobile computer) that is carried by a user, the computer is frequently used without being connected to a network.

Antivirus software is activated when a computer is activated, and periodically tries to acquire amendment of a virus definition file. However, in the case where the computer in question is not connected to a network, the antivirus software fails in updating the file. Further, when the computer stays without being connected to the network, there occurs a state that amendment of the virus definition file has not been acquired for a long time. If the computer activated in such a state is connected to the network, the computer is helpless against new kinds of viruses until the antivirus software acquires amendment of the virus definition file next time.

### DISCLOSURE OF THE INVENTION

An object of the present invention is to provide a technique of acquiring particular data through a network at the time of starting a particular program.

A first mode of the present invention provides a method in which a computer acquires particular data through a network, said method comprising steps of: detecting an activation instruction to activate a particular program; performing particular data acquisition processing for acquiring the particular data through the network when an activation instruction to activate the particular program is detected; and thereafter, activating said particular program whose activation has been instructed.

A second mode of the present invention provides a system for acquiring particular data through a network, comprising: a means that detects an activation instruction to activate a particular program; a means that performs particular data acquisition processing for acquiring particular data through the network when an activation instruction to activate the particular program is detected; and a means that activates said particular program whose activation has been instructed, after said particular data acquisition processing.

A third mode of the present invention provides a network security enhancing system for a computer, comprising: a means that activates processing of updating a security file at activation of a program that connects to a network and sends and receives communications, after processing of connection to said network and before other processing.

A fourth mode of the present invention provides a network security enhancing system for computer, wherein: said network security enhancing system comprises a means that automatically generates a control program; and said control program detects a program that is installed on the computer and connects to a network and sends and receives communications, activates processing of connecting to the network and processing of updating a security file, and thereafter activates said program that sends and receives communications.

A fifth mode of the present invention provides a network security enhancing program, wherein: said network security enhancing program makes a computer operate to activate processing of updating a security file at activation of a program that connects to a network and sends and receives communications, after connection to the network and before other processing.

And, a sixth mode of the present invention provides a network security enhancing program, wherein: said network security enhancing program makes a computer perform processing of automatically generating a control program; said control program detects a program that has been installed in the computer and connects to the network and sends and receives communication; and then, said control program activates processing of connection to said network, activates processing of updating a security file, and thereafter activates said program that sends and receives communication.

### BRIEF DESCRIPTION OF DRAWINGS

FIG. 1 is a block diagram showing an example of network security enhancing system;

FIG. 2 is a block diagram showing another example of network security enhancing system;

FIGS. 3(a)-3(d) are explanatory diagrams showing screen examples displayed in the course of operation of the network security enhancing system shown in FIG. 1;

FIGS. 4(a) and 4(b) are explanatory diagrams showing examples of setting screens used when a network connection control program is installed;

FIGS. 5(a) and 5(b) are operational flowcharts of the network connection control program;

FIGS. 6(a) and 6(b) are other operational flowcharts of the network connection control program;

FIG. 7 is an explanatory diagram showing an outline of operation of a method of acquiring particular data at the time of starting a program that sends and receives communications; and

FIG. 8 is an explanatory diagram showing a functional configuration of the network connection control program.

### BEST MODE FOR CARRYING OUT THE INVENTION

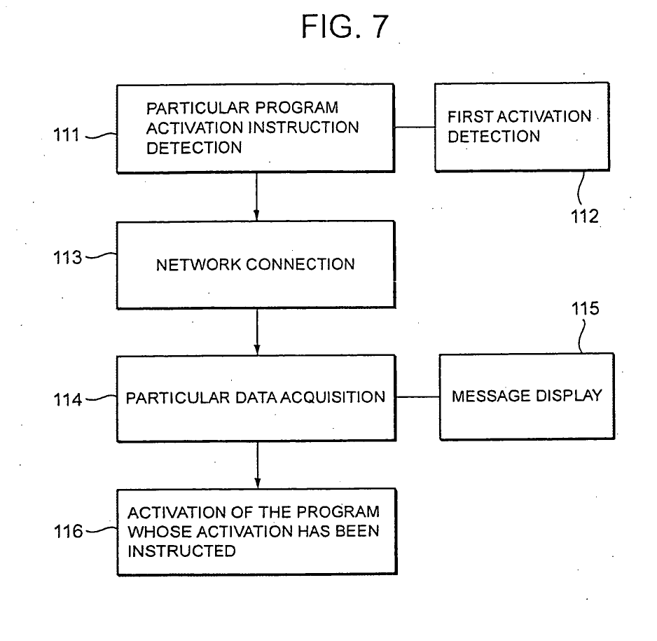

Now, embodiments of the present invention will be described referring to the drawings. First, referring to FIG. 7, will be described an embodiment that relates to a method of acquiring particular data through a network at the time of starting a particular program.

In the present embodiment, an instruction to activate a particular program triggers acquisition of particular data by a computer from another prescribed computer (for example, a specific server) before performing other processing. To that end, the computer performs particular program activation instruction detection processing 111. Namely, in the particular program activation instruction processing 111, the computer detects an instruction to activate the particular program, and, once an activation instruction is detected, the computer starts a sequence of processes that should be performed after the detection. In accordance with this sequence, the computer performs network connection processing 113, and performs particular data acquisition processing 114 for acquiring the particular data through the network. Thereafter, the computer performs particular program activation processing 116 for activating the particular program designated by the instruction.

As a result, at the time the particular program activation instruction detection processing 111 is performed, the particular program designated by the activation instruction is not activated. In other words, before activating the particular program designated, acquisition of the particular data is performed.

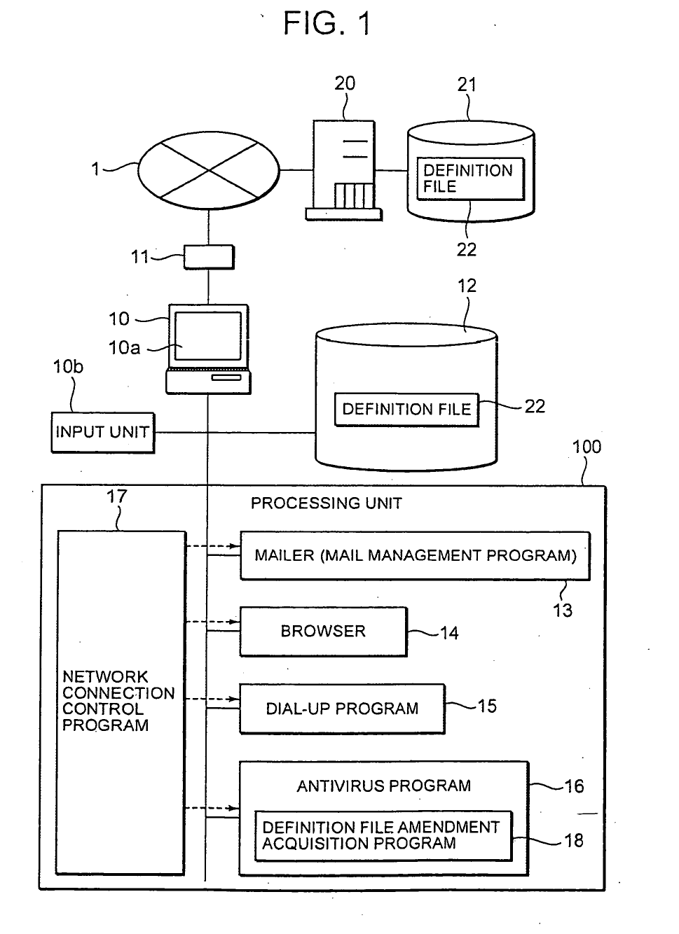

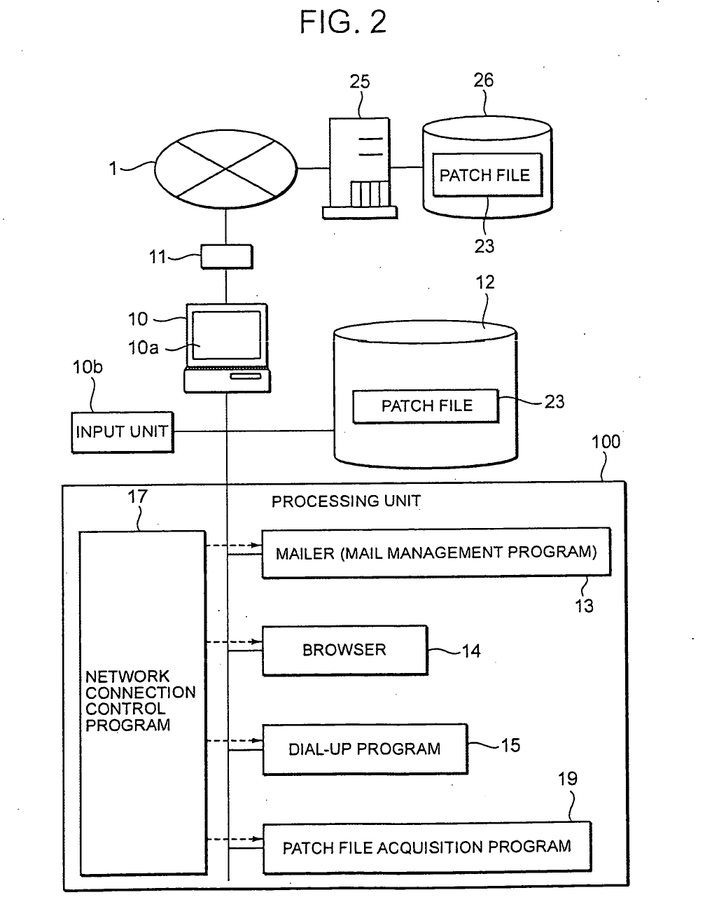

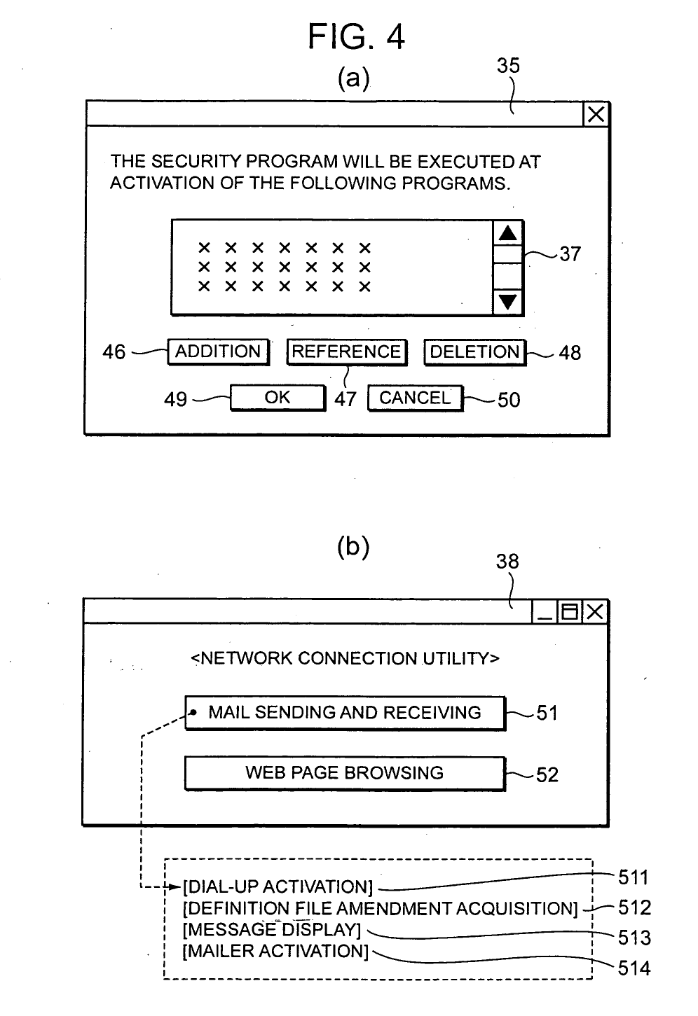

Here, the particular program as the object of an activation instruction to be detected is a previously determined program or a program designated by a user. For example, a program that sends and receives communications may be mentioned. In detail, may be mentioned a mail management program (a mailer) 13, a browser 14, a dial-up program 15, or the like, as shown in FIGS. 1 and 2. It can be arranged that particular programs are designated in advance in the system. Or, a user may designate all or a part of particular programs. Further, the user may change the designation, for example, by adding or deleting a particular program. Designation of a particular program will be described later (FIG. 4(a)).

Further, an instruction to activate a particular program is not limited to an instruction from a user through an input unit. For example, an activation instruction may be issued from an application program or the like.

The particular data are determined beforehand as data that should be acquired prior to activation of the particular program. For example, may be mentioned data used for updating antivirus software, data used for upgrading an application program, or the like. In detail, as data used for updating antivirus software, may be mentioned a virus definition file, a patch file, or the like. By acquiring such security software and performing update processing at the time of connecting a computer to a network, it is possible to enhance network security of the computer.

Here, the security file update processing means acquisition and updating of security software (which is used as security means during connection of a computer with a network) through the network. In detail, as the update processing, may be mentioned processing of acquiring amendment of a virus definition file used for an antivirus countermeasure, processing of acquiring a patch file, or the like. Amendment may be provided in various forms including a form of a difference data, a form of an amended and updated data file, or the like.

Preferably, this processing is performed at the time of activation of a program that sends and receives communications. Furthermore, this processing is performed after connection to the network and before other processing is performed. As a result, before the program that sends and receives communication starts operating, the newest security measure is taken. Thereafter, in the case where the connection with the network continues for a long time, it is preferable that the security file update processing is activated at regular intervals.

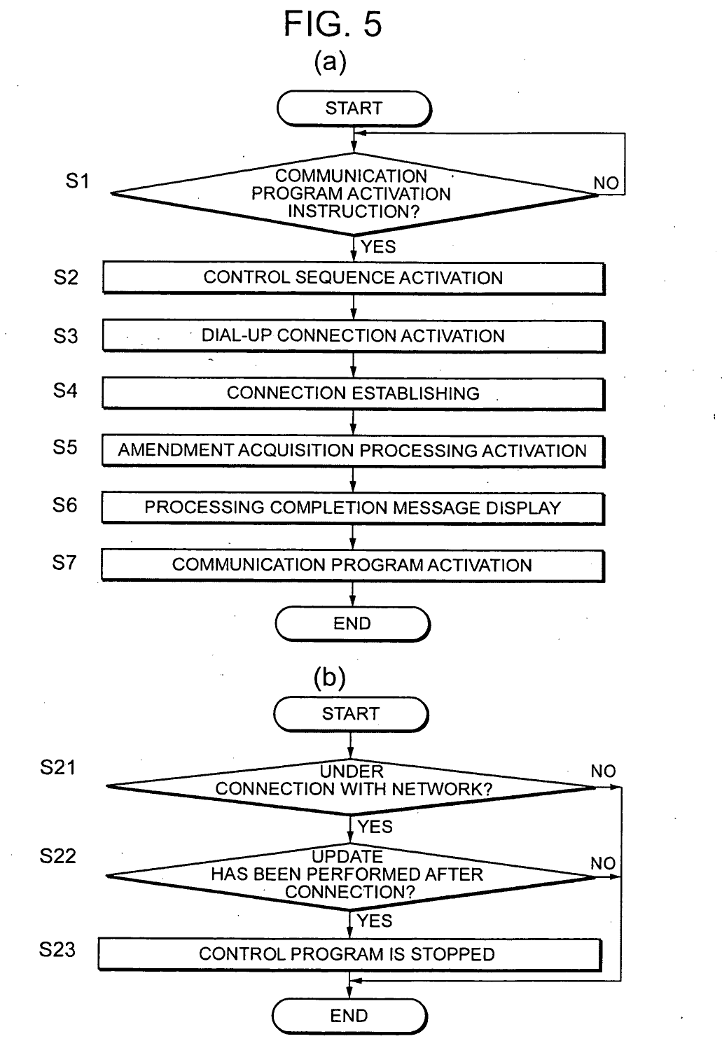

As for the above-described detection of an instruction to activate the particular program, it is sufficient to detect only a particular program activation instruction that is given first after the computer is connected to the network. Thus, to that end, it is possible to add first activation instruction detection processing 112 (See FIGS. 7 and 5(b)) for detecting the first activation instruction.

Thus, by arranging that the detection of an instruction to activate the particular program is performed only for the first time, it is possible to avoid the processing of acquisition of the particular data at the time of, for example, restarting or additional starting of the particular program. As a result, the particular program can be started rapidly.

In the case of acquisition of a network security file, an antivirus program can be made to collect amendment of an antivirus file or the like periodically after connection to a network. In that case, the network security enhancement according to the present invention does not need to be operated except the start time.

Further, it is possible to add message display processing 115 in which a message indicating a result of the particular data acquisition processing 114 on a display unit of the computer after the acquisition processing 114 has been performed. As a message indicating a result of the acquisition processing, may be mentioned a message indicating that the acquisition ends in success, that the acquisition ends in failure, or that the acquisition is not necessary, for example. In detail, after the antivirus file acquisition processing has been finished, the display unit is made to display a message reporting that the update has been finished. As a result, it is possible to notify the user that the processing of updating the antivirus file has been performed. Thus, the user can use the computer without anxiety in a state that the computer is connected with the network. Further, it is possible to notify the user that the computer is in a defenseless state, for example, by displaying a message to the effect that the antivirus file can not have been updated owing to an operation error or the like. Thus, the user can take a countermeasure, for example, by disconnecting the computer from the network.

The above-described processing 111-116 can be performed by the computer 10 shown in FIG. 1 or 2 mentioned below. In detail, each processing is performed when a processing unit 100 of the computer 10 executes a program corresponding to the processing. Various programs are loaded onto the processing unit 100 to realize the respective functions.

In embodiments of the present invention, as the programs that makes the computer realize the above-mentioned processing functions, are used a network connection control program 17, a program for connecting to a network, a program for acquiring the particular data through the network, and the like. When the processing unit 100 of the computer 10 executes these programs, a system for acquiring the particular data is constructed, and a method of acquiring the particular data is realized.

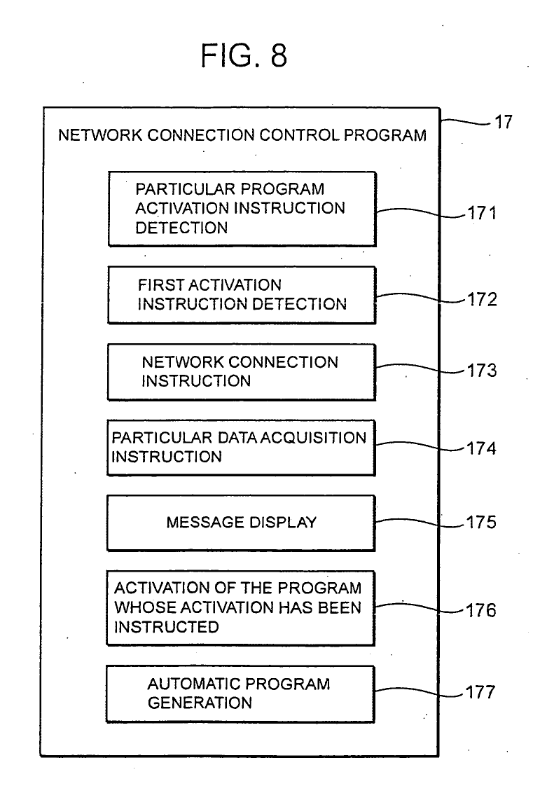

FIG. 8 shows an example of a plurality of programs that constitute the network connection control program 17. In addition to the programs that realize the above-described functions, the programs shown in FIG. 8 include a program that automatically generates the network connection control program 17 itself.

Namely, the network connection control program 17 comprises: particular program activation instruction detection 171; first activation instruction detection processing 172; network connection instruction 173; particular data acquisition instruction 174; message display processing 175; particular program activation processing 176; and automatic program generation processing 177.

Here, the particular program activation instruction detection 171 is executed for detecting an instruction to activate the particular program activation processing 176. For example, the below-described examples shown in FIGS. 1 and 2 detect an instruction to activate a mailer 13, a browser 14, a dial-up program 15 or the like as the particular program. By executing the particular program activation instruction detection 171, the above-described particular program activation instruction detection processing 111 shown in FIG. 7 is realized.

Further, when an activation instruction is detected, the particular program activation instruction detection 171 starts a sequence of processes that should be performed after the detection. Namely, the particular program activation instruction detection 171 starts the sequence in which the first activation instruction detection processing 172, the network connection instruction 173, the particular data acquisition instruction 174, the message display processing 175, and the particular program activation processing 176 are executed successively.

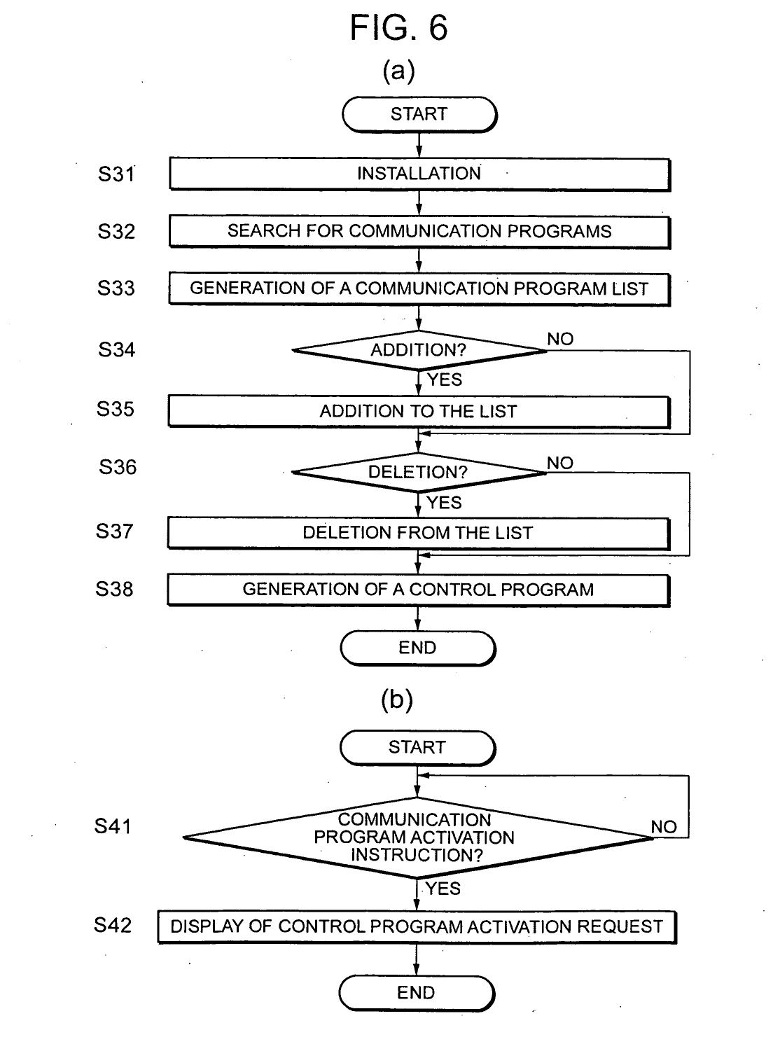

The network security enhancing systems shown in FIGS. 1 and 2 are examples of application of this network connection control program 17 to enhance network security. Further, FIGS. 5 and 6 show examples of a process flow of the network connection control program 17.

Thus, the present invention provides the method of enhancing network security, in which, at the time of starting a particular program such as a program that connects to a network to send and receive communications, a security file is acquired as particular data after the processing of connection to the network and prior to other processing. Further, the present invention provides the system to implement the method.

Next, will be described an embodiment in the case where the present invention is applied to enhancement of network security of a computer.

FIG. 1 is a block diagram showing an example of a network security enhancing system. As shown in FIG. 1, a computer 10, which is an object of the security enhancement, is connected to a network 1 through a network interface 11.

The network 1 is connected with a server 20 that is a supplier of an antivirus program. The server 20 is provided with a storage unit 21. The server 20 provides a definition file 22 to the computer 10 of a user through the network 1.

The computer 10 is provided with a storage unit 12 and a processing unit 100. Further, the computer 10 is provided with a display unit 10a and an input unit 10b. The input unit 10b includes a keyboard, a mouse, and the like.

On the processing unit 100, are loaded a mailer (a mail management program) 13, a browser 14, a dial-up program 15, an antivirus program 16, and a network connection control program 17. Here, only the programs relating to the description of the present invention are referred to. Programs executed on the processing unit 100 are not limited to these programs. The programs executed on the processing unit 100 are stored in the storage unit 12 and loaded onto the processing unit 100.

The mailer (mail management program) 13 is a program that controls sending and receiving of mail. The browser 14 is a program used for Internet browsing. The dial-up program 15 is a program that controls dialup connection to a preset telephone number.

The antivirus program 16 is a program that performs virus checking. Operation of the antivirus program 16 requires a definition file 22. A supplier of the antivirus program 16 provides an amendment file of the definition file 22 each time a new virus appears.

Accordingly, the antivirus program 16 includes a definition file amendment acquisition program 18 (i.e., a program for acquiring particular data) for acquiring amendment of the virus definition file. The antivirus program 16 activates the definition file amendment acquisition program 18 periodically at preset time intervals.

The function of the definition file amendment acquisition program 18 is to download the definition file 22 periodically from the server 20 at predetermined timing, and to store the definition file 22 into the storage unit 12. Namely, the definition file amendment acquisition program 18 updates the definition file 22 stored in the storage unit 12.

When a user activates one of the mailer (mail management program) 13, the browser 14, and the like to use it, then the network connection control program 17 activates the dial-up program 15 in the first place, and then the definition file amendment acquisition program 18 of the antivirus program 16. Thus, a function of the network connection control program 17 is to update the definition file 22 to the newest one 22 before execution of the program that sends and receives communications. According to this invention, at the time of starting a program (such as the mailer 13, the browser 14, the dial-up program 15 or the like) that connects to a network and communicates through the network, antivirus software is automatically made to perform the processing of acquiring amendment of a definition file. As a result, for example, a mobile computer can communicate safely through a network, always using the newest definition file. Here, the activation of the program that sends and receives communications is not limited to the case where a user directly gives an activation instruction, but includes the case where an activation instruction is given through an application.

In the examples shown in FIGS. 1 and 2, the network connection control program 17 has the functions of performing the particular program activation instruction detection 171, the network connection instruction 173, the particular data acquisition instruction 174, the message display processing 175, and the particular program activation processing 176 for activating the particular program whose activation has been designated, out of the various functions shown in FIG. 8.

FIG. 2 is a block diagram showing another example of network security enhancing system. The example shown in FIG. 2 will be described in comparison with the example shown in FIG. 1.

The computer 10 is provided with a patch file acquisition program 19 instead of the antivirus program 16. It is favorable that one computer is provided with both the antivirus program 16 and the patch file acquisition program 19. Here, however, for the sake of convenience of description, each example is described separately.

The network connection control program 17 operates to activate the patch file acquisition program 19 after activation of the dial-up program 15. The network 1 is connected with a server 25. This server 25 is managed by a supplier who supplies, for example, the mailer (mail management program) 13, the browser 14, and the like. A storage unit 26 provided to the server 25 stores patch files 23 for improving security of the mailer (mail management program) 13 and the browser 14. A function of the patch file acquisition program 19 is to download patch files 23 through the network 1 and to store the downloaded patch files 23 into the storage unit 12. Patch files 23 are used to update the mailer (mail management program) 13, the browser 14 and the like at proper times.

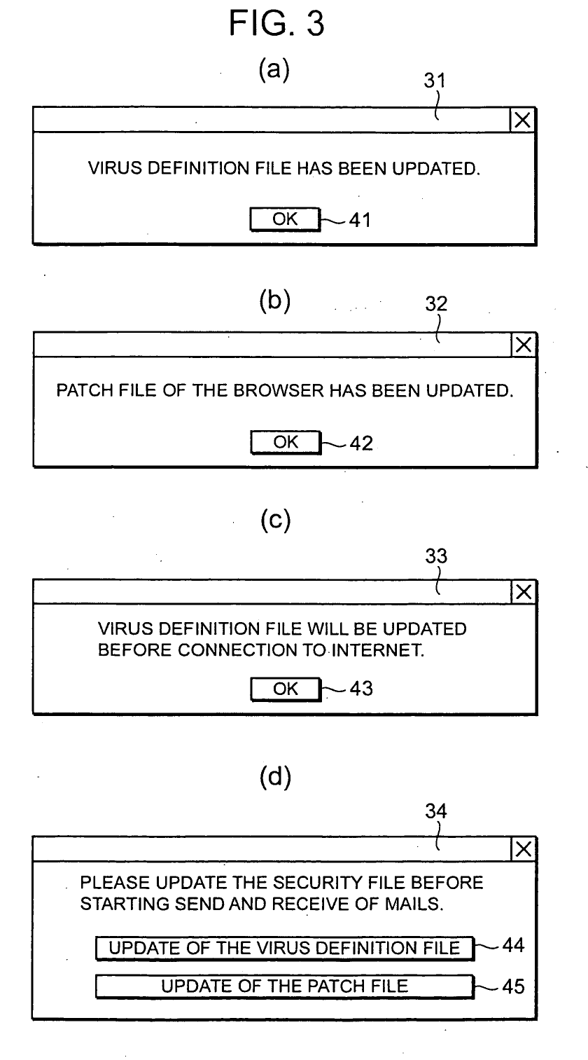

FIGS. 3(a)-3(d) are explanatory diagrams showing screen examples displayed in the course of operation of the network connection control program 17 shown in FIG. 1.

As described above, the computer 10 is provided with various functions 171-176 as the network connection control program 17, as shown in FIG. 8. For example, when an instruction to activate the mailer 13 is given, the processing unit 100 detects the instruction to activate the mailer 13 and performs processing of activating the dial-up program 15. As a result, network connection conditions are set. Next, the processing unit 100 activates the definition file amendment acquisition program 18 of the antivirus program 16 so that the definition file amendment acquisition program 18 performs acquisition of amendment of the definition file.

At that time, the processing unit 100 performs the massage display processing 175 to display the screen 31 of FIG. 3(a) on the display unit 10a, informing the user that the processing has been finished. Here, a message “the virus definition file has been updated” is displayed to the user. This informs the user that he can use the mailer (mail management program) 13 safely.

The processing unit 100 closes the screen 31 when the user clicks the button 41. Thereafter, the processing unit 100 activates the mailer (mail management program) 13 to make sending and receiving of mails possible as usual.

Generally, when a browser displays its screen, the browser already starts to download an initial screen through a network. Accordingly, it is favorable to have performed the processing of updating the definition file 22, the processing of patching the browser, and the like, before displaying the screen of the browser.

The processing of acquiring amendment of the virus definition file may be performed according to the conventional method. For example, amendment in the XML database format may be downloaded from the server to update the virus definition file. Further, acquisition and application of a patch file 23 (which is distributed from a supplier of an application program for the purpose of repairing a security hole of the application program) may be performed according to a similar procedure. FIG. 3(b) shows an example of a display screen 32 in the case of acquiring and applying a patch file 23.

In the above examples, the processing unit 100 automatically acquires the definition file 22 and the patch file 23. However, the present invention is not limited to this. For example, it may be arranged that user's consent is obtained before performing processing of updating the definition file 22, a patch file 23, or the like. In that case, a message such as “the virus definition file will be updated before connection to Internet” is displayed on the display unit 10a, as shown in the screen 33 of FIG. 3(c).

When a click of the button 43 is received through the input unit 10b, the processing unit 100 judges that user's consent has been obtained and activates the definition file amendment acquisition program 18. Similar control may be performed as for activation of the patch file acquisition program 19.

Otherwise, it may be arranged that the processing of updating the definition file 22 or a patch file 23 is performed by user's operation. As shown in the screen 34 of FIG. 3(d), the processing unit 100 displays a message such as “please update the security file before starting sending and receiving mails” immediately after setting the network connection conditions. When a click of the button 44 is received in this screen through the input unit 10b, the processing unit 100 performs the processing of updating the definition file 22. Further, when a click of the button 45 is received through the input unit 10b, the processing unit 100 performs the processing of updating the patch file 23.

In detail, a message “please update the definition file” is displayed in a screen at the time of activating the mailer 13, the browser 14, the dial-up program 15, or the like. The message may be outputted by voice. The processing of updating the security file does not need to be interlocked with a program that sends and receives communications. In that case, unnecessary file update can be avoided.

Further, it may be arranged that, at the time of activation of the browser 14, a message requiring activation of the processing of updating the security file is outputted before the screen is displayed. In this case, a message “please update the definition file and the patch file” is displayed. Thus, security is ensured although updating is not automated.

FIG. 4 is a diagram explaining operation at the time the network connection control program 17 is installed. Favorably, the network connection control program 17 has the following functions so that the program 17 can be installed onto many computers and can operate independent of models of the computers.

First, as shown in the screen 35 of FIG. 4(a), communication software of the computer, onto which the network connection control program 17 is to be installed, is searched for. And, software that becomes an object of the control is determined. The screen 35 is provided with a list box 37 and buttons 46-50. Immediately after the installation, the processing unit 100 displays in the list box 37 a list of communication software prepared in the computer. Among the listed software, the user selects unnecessary software except for the mailer and browser which are used usually and clicks the delete button 48. Then, the processing unit 100 deletes the designated software. In the case where other communication software exists, the processing unit 100 detects a click of the addition button 46 and performs processing of addition. When the reference button 47 is clicked, the processing unit 100 displays a list of reference objects.

Thus, it is possible to determine communication software that becomes an object of the control. The processing unit 100 receives user's click of the OK button 49 through the input unit 10b. Further, the processing unit 100 receives a click of the cancel button 50 to cancel any kind of processing.

After the above-described preparation processing, the processing unit 100 generates a start screen as shown in FIG. 4(b) according to the network connection control program 17. The start screen 38 is a screen of a new application for using mail and Internet while aiming at the network security enhancement as described above. This screen 38 has a heading such as “network connection utility” for example.

When a click of the button 51 is received through the input unit 10b, the processing unit 100 activates the mailer 13. When a click of the button 52 is received through the input unit 10b, the processing unit 100 activates the browser 14. The network connection control program 17 includes a form for displaying the screen 38 as shown in FIG. 4(b) and a list of commands that are executed in response to click events of the buttons 51 and 52. Meaning of commands is as shown under the screen 38. For example, correspondingly to selection of “sending and receiving mails”, the network connection control program 17 includes a group of commands meaning [Dial-up activation] 511, [Definition file amendment acquisition] 512, [Message display] 513 and [Mailer Activation] 514.

FIGS. 5(a) and 5(b) are operational flowcharts of the network connection control program 17. Here, FIG. 5(a) is a detailed operational flowchart of the network connection control program 17. Operation of the network connection control program 17 is realized by the above-described functions 171-176 shown in FIG. 8.

In the step S1, the processing unit 100 executes the particular program activation instruction detection 171 to display the screen 38 shown in FIG. 4(b) and awaits an instruction to activate a communication program. When the button 51 is clicked through the input unit 10b to give an instruction to activate the mailer 13, the processing unit 100 judges that an instruction to activate the communication program corresponding to the particular program designated has been given, and proceeds from the step S1 to the step S2. In the step S2, the processing unit 100 starts a control sequence. The control sequence means a series of processes from the step S3 through the step S7.

Next, in the step S3, the processing unit 100 executes the network connection instruction function 173, to activate the dial-up program 15. Then, the processing unit 100 executes the dial-up program 15 to establish a connection in the step S4. As a result, connection to the network 1 becomes possible. In the step S5, the processing unit 100 executes the particular data acquisition instruction function 174, to activate the definition file amendment acquisition program 18. The processing unit 100 executes the definition file amendment acquisition program 18 to download amendment of the definition file 22 from the server 20. Of course, it is possible to execute download of the patch file 23 in addition.

Thereafter, in the step S6, the processing unit 100 executes the message display processing 175, to display a message of completion of the processing. For example, this message is displayed on the display unit 10a as shown in FIG. 3(a).

Last, in the step S7, the processing unit 100 activates the communication program to end the processing. Namely, the processing unit 100 activates the mailer 13, which is the communication program detected by the particular program activation instruction detection function 171.

FIG. 5(b) shows a flow of processing according to the program of the first activation instruction detection processing 172 (See FIG. 8) provided as an option for the control program. There is a case where the communication program is ended once after the connection to the network has been performed and the processing of updating the definition file 22 and the patch file 23 has been already performed. In that case, if the connection to the network continues, the definition file amendment acquisition program 18 and the patch file acquisition program 19 continue to be in normal operation. Thus, the processing of updating the definition file 22 and the patch file 23 is automatically performed at regular intervals. Thereafter, when the communication program is activated again, it is not necessary to perform the processing of updating the definition file 22 and the patch file 23 again at the time of the activation. Otherwise, it takes time to activate the communication program and the operability becomes worse.

Thus, in the first activation instruction detection processing 172, it is judged in the step S21 of FIG. 5(b) whether connection with the network has been established. When the connection with the network has been established, then it is judged in the step S22 whether update has been performed since the start of the connection. When a history of update is recorded at least once since the start of the connection, activation of the control program is stopped in the step S23. Of course, once connection to the network is ended, the control program is activated.

Next, as another embodiment of the present embodiment, will be described an example where an orbit control program is automatically generated according to the automatic program generation processing 177 of the network connection control program 17. The automatic program generation processing 177 is a program that generates an activation control program automatically. The activation control program detects a program installed in a computer for connecting to a network and for sending and receiving communications. Then, the activation control program activates network connection processing, activates security file update processing, and thereafter activates the detected program that sends and receives communications.

Automatic generation of the orbit control program requires a control program that activates network connection processing, activates security file update processing, and thereafter the program that sends and receives communications. However, different computers have different programs that send and receive communications. Accordingly, a means for detecting a communication program installed on a computer and for automatically generating an activation control program is provided in advance. As a result, the above function can be easily given to various computers on which respective computer programs have been installed.

FIGS. 6(a) and 6(b) are other operational flowcharts of the network connection control program. FIG. 6(a) is a flowchart showing initializing operation at the time of installing the network connection control program 17.

First, when the installation is finished in the step S31, the processing unit 100 searches for a communication program in the step S31. Then, in the step S33, the processing unit 100 generates a communication program list. Here, the result is displayed on the display unit 10a. When there is a request for addition in the step S34, the processing unit 100 performs processing of adding a communication program to the list. When there is a request for deletion in the step 36, the processing unit 100 deletes a part of the list in the step S37. Last, in the step S38, the processing unit 100 generates an activation control program.

FIG. 6(b) is a program flowchart in the case where control of activation of the network connection control program 17 is entrusted to the user. Namely, when there is an instruction to activate a communication program in the step S41, the processing unit 100 displays a screen that requests activation of the control program on the display unit 10a in the step S42. When some button is clicked through the input unit 10b, the corresponding program is activated. This processing has been described above.

As described above, at the time of activating a program that connects to a network to send and receive communications, the processing of updating a security file is always activated after the processing of connecting to the network and before other processing. As a result, for example, it is possible to protect the computer certainly against virus intrusion even when the computer is abruptly connected to a network after a long time has elapsed without updating the definition file.

Each of the above programs may be constituted by combining program modules that is independent from one another, or may be constructed as an integrated program. All or a part of the processes controlled by the computer programs may be performed by hardware having the equivalent functions. Or, the above programs may be used being incorporated in an existing application program. The above computer programs implementing the present invention may be recorded on a computer-readable record medium such as a CD-ROM for example, and used being installed onto any information processing device. Further, the above computer programs may be used being downloaded into a memory of any computer through a network.

1. A method in which a computer acquires particular data through a network, said method comprising steps of:
detecting an activation instruction to activate a particular program;
performing particular data acquisition processing for acquiring the particular data through the network, when an activation instruction to activate the particular program is detected; and
thereafter, activating said particular program whose activation has been instructed.

2. A method according to claim 1, wherein:
said activation instruction to activate the particular program is an activation instruction to activate a program that sends and receives communication.

3. A method according to claim 2, wherein:
said particular data acquisition processing is processing of updating a security file.

4. A method according to one of claims 1 and 2, wherein:
activation of said particular program whose activation has been instructed is activation of said program that sends and receives communications and whose activation has been instructed.

5. A system for acquiring particular data through a network, comprising:
a means that detects an activation instruction to activate a particular program;
a means that performs particular data acquisition processing for acquiring particular data through the network, when an activation instruction to activate the particular program is detected; and
a means that activates said particular program whose activation has been instructed, after said particular data acquisition processing.

6. A system according to claim 5, wherein:
said means that gives the activation instruction to activate said particular program is a means that gives an activation instruction to activate a program that sends and receives communications.

7. A network security enhancing system for a computer, comprising:
a means that activates processing of updating a security file at activation of a program that connects to a network and sends and receives communications, after processing of connection to said network and before other processing.

8. A network security enhancing system according to claim 7, further comprising:
a means that displays a message reporting completion of said processing of updating the security file, after the processing has been completed.

9. A network security enhancing system according to claim 7, comprising:
a means that detects first activation of a program that connects to the network and sends and receives communications, in a state that an already-operating computer is no connected to the network; and
a means that activates the processing of updating the security file at activation of said program, after processing of connection to said network and before other processing.

10. A network security enhancing system according to claim 7, wherein:
said processing of updating the security file is processing of acquiring amendment of a definition file used for an antivirus countermeasure.

11. A network security enhancing system according to claim 7, wherein:
said processing of updating the security file is processing of acquiring a patch file.

12. A network security enhancing system according to claim 7, further comprising:
a means that activates the processing of updating the security file at activating a browser and before displaying a screen.

13. A network security enhancing system according to claim 7, further comprising:
a means that outputs a message requesting activation of the processing of updating the security file, after said program that connects to the network and sends and receives communications connects to the network and before said program starts communication operation.

14. A network security enhancing system according to claim 7, further comprising:
a means that outputs a message requesting activation of the processing of updating the security file, at activation of a browser and before displaying a screen.

15. A network security enhancing system for computer, wherein:
said network security enhancing system comprises a means that automatically generates a control program; and
said control program detects a program that is installed on the computer and connects to a network and sends and receives communications, activates processing of connecting to the network and processing of updating a security file, and thereafter activates said program that sends and receives communications.

16. A network security enhancing program, wherein:
said network security enhancing program makes a computer operate to activate processing of updating a security file at activation of a program that connects to a network and sends and receives communications, after connection to the network and before other processing.

17. A network security enhancing program, wherein:
said network security enhancing program makes a computer perform processing of automatically generating a control program;
said control program detects a program that has been installed in the computer and connects to the network and sends and receives communication; and
then, said control program activates processing of connection to said network, activates processing of updating a security file, and thereafter activates said program that sends and receives communication.
